(19) United States
(12) Patent Application Publication
(10) Pub. No.: US 2010/0198427 A1
(43) Pub. Date: Aug. 5, 2010

(54) Open Architecture For Dynamic Vehicle Network

(75) Inventors: Kenneth A. Fogelstrum, Fort Wayne, IN (US); Francisco A. Gutierrez, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/366,398

(22) Filed: Feb. 5, 2009

(51) Int. Cl. G06F 19/00

(52) U.S. Cl. 701/1

(57) ABSTRACT

A self-configuring and self-learning network optimizes itself for battery usage, and allows users to simply mount modules implementing new functionality to the vehicle at any location on the vehicle. The use of network zones and wireless gateways between zones reduces network traffic within zones by isolating data not required outside a zone from the other zones.

### BACKGROUND OF THE INVENTION

1. Technical Field

The present invention relates to motor vehicle control networks.

2. Description of the Problem

In a commercial vehicle such as a Class 8 truck, there are innumerable combinations of both original equipment manufacturer (OEM) and aftermarket accessories that can be added to the vehicle to support the various vocations to which the vehicle is applied. Many of the aftermarket accessories require sensors or actuators, and control modules for these devices, along with the associated wiring and connectors. From time to time sensor technologies change and new applications are developed. The implementation of few features may require the availability of a control module that receives analog or digital sensor signals via hard-wired connections. While the vehicle's electrical control unit (ECU, a type of body computer) can be used if sufficient input ports are available, often an additional controller module needs to be added to the system. The transmission of signals between a sensor and a module is normally achieved by placing a voltage on a signal line, which is read by the receiving module. Sometimes, a special communication protocol is used, such as LIN or CAN, which allows use of a time division multiplexing of control and data signals on a single physical transmission medium, thus limiting the number of signal wires. But even this partial solution still requires wires for the delivery of power to the devices and to ground the devices. And a connection into the transmission medium is still required too. One way or another, the adding of new electrical or electronically controlled features has required adding wiring to the vehicle's harness. This, in turn, requires additions or changes to routing and clipping, which varies widely from vehicle to vehicle. Therefore, a single sensor addition or change may require several different harnesses and other changes in order to accommodate all of the intended vehicles. Thus, the cost and time required to add even a simple feature is sometimes makes otherwise desirable changes impractical.

Some of the most common service issues in commercial vehicles are related to wiring or connector failures. Each addition of wiring to the wiring harness to support a device or module increases the possibility of an in service failure. If a sensor or actuator control module is damaged, all of the sensors and actuators connected to the module are rendered useless. A damaged module, or an issue with electrical and electronic connections to the module can force a vehicle out of service.

A wired network holds limited capability for dynamic changes to a system (addition, subtraction, or movement of sensors and modules), or for enabling a reduction in the required number of modules. A wireless network can improve upon this. However, there still may be compatibility issues with various protocols, along with signal routing issues when system changes occur dynamically.

A physical communication medium on a vehicle used for time division multiplexed communications will still have a limited capacity for message traffic. As more modules that are added to the system, the more of this limited capacity is used and the greater the possibility of an unacceptable level of data traffic collisions. As available capacity is lost, designers lose the ability to add new features that require such communication.

To add a new feature to a vehicle, it has usually been necessary to reprogram a central controller, such as an ECU or an electrical system controller (ESC). Any number of different program loads can be requested by customers, making vehicle electronic configuration difficult or complex.

Naturally, wireless networks require power, as well. Even if power is supplied to sensors by hard wired power and ground, connections, wiring must still be added. This reduces the advantages hoped for when implementing a wireless system, in terms of system complexity and quality. However, signal wires are not required, so some benefit remains. If batteries are used to power the sensors, potential issues arise in terms of battery life and reliability.

Some prior art references have recognized some of these difficulties. U.S. Pat. No. 6,629,032 taught a wireless vehicle communication system which provided a plurality of electrical control units with wireless transceivers and a dedicated gateway controller. Subsets of electrical control units selected on functional relatedness were organized into networks by joint use of a particular communication code (more precisely a pseudo-random noise code). Communication between networks occurred through the gateway controller.

### SUMMARY OF THE INVENTION

It is an object of the invention to reduce system complexity and free the manufacturers and operators of these vehicles from the restraints of a hard-wired sensor/actuator network.

It is another object of the invention to reduce electrical failures, increase fault tolerance, and add redundancy.

It is a still further object of the invention to address the issue of network power, via rerouting, and battery conservation, among other means.

It is yet another object of the invention to allow changes or additions to the system which are “plug-and-play”, so that changes can be made transparently and seamlessly without operator intervention for system reconfiguration. With the ability to provide new features which can simply be “bolted on” to the vehicle, and automatically configured through the network, new or changed features would be less expensive and simpler to implement.

It is still another object of the invention to greatly increase data transmission capacity to allow for much greater flexibility in design, and to provide infrastructure for unknown future features to be added. It is a further aim to provide increased fault tolerance and redundancy.

The invention provides a self-configuring and self-learning network that optimizes itself for battery usage, and allows users simply to mount modules and devices implementing new functionality on the vehicle at any location on the vehicle. By simply adding a feature software module to the central controller, the system will configure itself and be ready for use. Optionally, the added feature module can download its operating program or algorithms to the central controller automatically, so no manual update to the controller is necessary. Network protocol accepts any kind of sensor or actuator device that uses radio frequency (RF) communication. Therefore, any RF sensor or actuator device will be added to the network dynamically, without regard to any particular platform or protocol. By implementing multiple networks divided by zones, the system is able to accommodate a greater number of modules and devices and a greater volume of bus traffic. Gateways between zones block the passing of messages in one zone not of interest to modules and controllers in other zones. Zones are preferably spatial rather than logical, and may include a mix of wireless and bus communication traffic, which reduces the need for some wiring and eases the task of making the system dynamically scalable. Additionally, the architecture creates an environment where the presence of faults can be more readily detected and bypassed or even repaired. Similarly, the addition and withdrawal of network objects is dynamically recognized, with the result that the system is effectively dynamically scalable.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a system architecture schematic;

FIG. 2 is a system network topology superimposed on a vehicle chassis;

FIG. 3 is a system block diagram for a wireless gateway; and

FIG. 4 is a high level block diagram of the network of FIG. 2.

FIG. 5 is a state diagram.

### DETAILED DESCRIPTION OF THE INVENTION

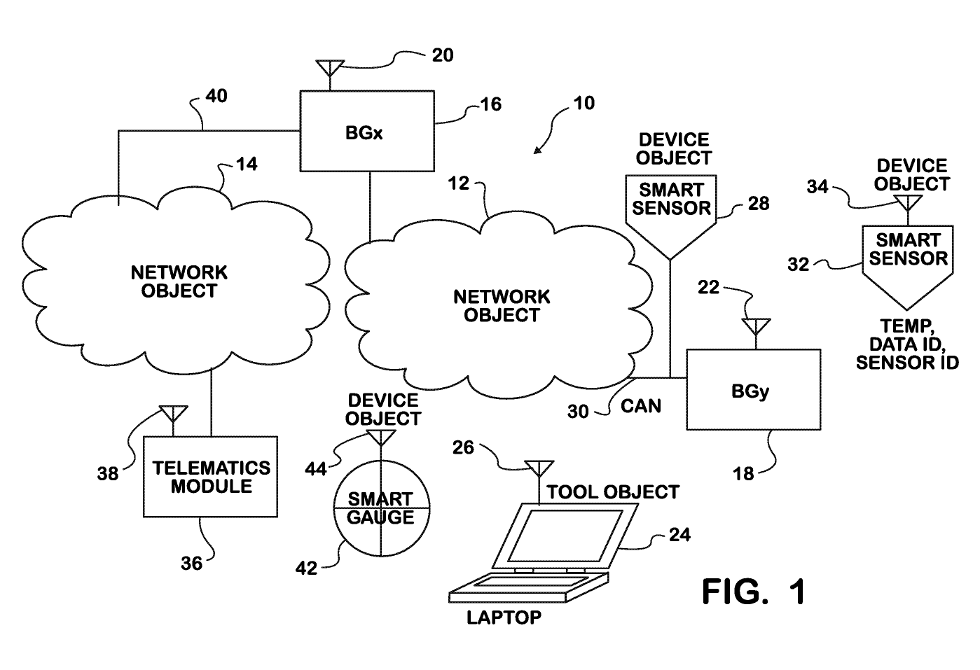

Referring now to the drawings and in particular to FIG. 1 a network architecture 10 is shown which illustrates various possible components, and a possible combination of those components, in a preferred embodiment of the invention. The highest ranking components in the network hierarchy are network objects 12, 14. Network objects 12, 14 may be implemented as SAE J1939 compliant controller area networks (CAN), or they be implemented using any one of plurality of other supported network protocols. For example, network object 12 may include a CAN compliant cable 30 as a hardwire communication link while network object 14 includes a local area network (LAN) bus as its hardwire communication link. Network objects 12, 14 communicate with one another when required through bridge gateways 16, 18. A bridge gateway 16, 18 may provide either a wireless or hardwire connection between the network objects 14, 16. A bridge gateway provides translation of messages if the network objects operate under different communication protocols and the messages require transfer between network objects. Bridge gateways connected to CAN systems are programmed to determine classes of messages which require such transfer. A network object may be entirely wireless or include a hardwire communication link such as a bus or twisted pair cable.

Network objects 12, 14 may contain any number of device objects (DO) and modules. A device object is categorized as “smart” or “dumb” and may be a sensor, display, actuator, or other device. A “smart” device may include sufficient local data processing capability to recognize the communication protocol of its local network zone and format messages for the local network and will at least be capable of independent operation. A “dumb” device may be a slave device of another controller, or a module, of its local network object. A variety of device objects are illustrated including an aware device object 36, which includes an antenna 38 for wireless communication with a gateway and a physical connection into a communication link 40 for network object 14. Device object 36 is a telematics module, which provides wireless connection to remote operational centers for downloads of data and programs or uplinking of operational data. An antenna 38 is provided.

Another device object, a smart sensor 28, provides only a physical link to CAN cable 30 of network object 12. A second smart sensor 32 includes an antenna 34 and is linked into a network object by a wireless link to a local bridge gateway 18. Sensor transmit data. Gauges may be provided, such as device object 42 which take data off a network object for display. Device object 42 includes an antenna 44 for wireless linkage to a network object. All of these devices are intended for installation on a vehicle.

Tool objects (TO) are devices not intended for permanent installation on a vehicle and which can tap into a network object 12, 14, preferably wirelessly (as illustrated by a laptop computer 24 with its associated antenna 26) or by a diagnostic port if necessary. Tool objects temporarily join a local zone and are used by network administrators and technical personnel to monitor bus traffic, configure device objects if required and carry out other diagnostic activities.

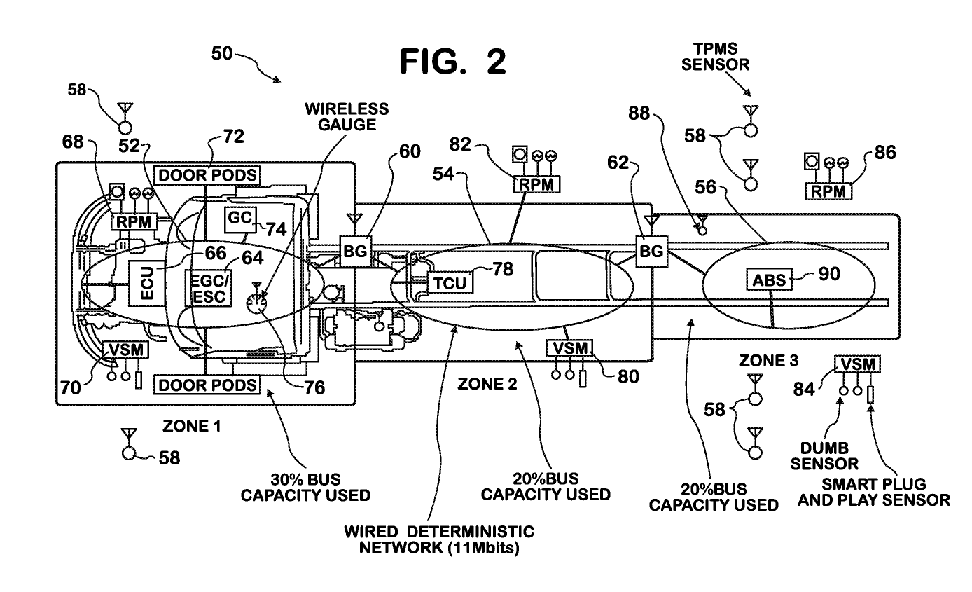

Bridge gateways 16,18 allow any number of network objects to be interlinked. In the embodiment shown in FIG. 2, a commercial vehicle deploying three network objects is depicted. A base vehicle that provides only basic motive transportation would typically include only one network object, which would connect vocational controllers such as a brake controller, transmission controller, engine controller and body computer or electrical system controller might be present in addition to the bridge gateway controller. Due to the operational criticality of the bus connecting such elements it may be considered problematic to load that bus with additional controllers, sensors and gauges which generate or attract bus data traffic. As a truck is equipped with additional features it could be equipped with the base network object and a secondary network object linked to the first by a bridge gateway. The additional features would be accommodated by the secondary network object. Finally, a trailer could be equipped with a local network which can become either the second or third network object in a compound vehicle when the trailer is attached to the base vehicle, or to the enhanced base vehicle if equipped with a bridge gateway. Detachment of the trailer would result in reversion of the base vehicle to its base network topology. Thus the system is dynamically scalable and may include a number of network objects greater or fewer than three, all achieved by the incorporation of bridge gateways to add network objects.

FIG. 2 illustrates a control system for a commercial vehicle based on an extended truck chassis 50, different areas of which are covered by distinct network objects 52, 54, 56, locationally corresponding to spatially distinct zones 1, 2 and 3, respectively. The zones are illustrated two dimensionally as non-overlapping sectors laid out from front to back along the truck chassis 50. In terms of physical connections it is expected that modules and sensors having a direct physical connection to the electrical or optical cabling of the vehicle for signaling will be located in the zone corresponding to the cabling to which they are attached. Exceptions to such a rule due to difficulties in attaching a particular node to the data transmission means are possible. The cabling, as distinguished from wireless links, is considered the physical layer of the network objects. To illustrate the flexibility of the system topology, some operationally essential control units have been distributed among the network objects 54, 56 outside the base network object 52. Functionally related devices are usually distributed among the local zones rather than being attached to a network organized by function of the devices. For example, six wireless tire pressure management sensors (TPMS) 58 are located on the chassis 50. Two forward TPMS devices 58 are associated with zone 1 and four aft installed TPMS devices 58 are associated with zone 3. The forward TPMS devices 58 are linked into network object 52 by wireless links with bridge gateway (WG) 60. The four aft installed TPMS devices 58 are linked into network object 56 by wireless links implemented by an aft bridge gateway (WG) 62. Modules, such as vehicle sensor module 80 or remote power module 82 may be used as an interface between the network object and sensor or actuator device objects.

Moving from front to back of chassis 50, a forward network object 52 is shown including representative modules such as vocational controllers, including an electrical system controller 64 and an engine controller 66. Representative of other elements of a vehicle with communication requirements are actuator devices 72 for door systems, such as locks and power windows (door pods) and a non-specified controller 74. A remote power module 68, used generally to actuate systems and a vehicle sensor module 70, used for incorporating additional sensors (e.g. ambient temperature gauge, anti-lock brake sensors, etc.) are also attached to and incorporated in the forward network object 52. A wireless display gauge 76 is physically located in the forward part of the vehicle, and will typically be included in network object 52 through a wireless link to bridge gateway 60, though it may be incorporated into middle network object 54.

A middle network object 54, which is physically located in zone 2 provides a physical data link between bridge gateways 60 and 62. Three device objects are illustrated as part of network object 54, a transmission control unit (TCU) 78, a remote power module 82 and a vehicle sensor module 80, all of which are physically connected to the network object physical communication link. Further aft on chassis 50 is an aft network object 56 which includes yet another remote power module 86 and vehicle sensor module 84. A wireless sensor 88 is located in zone 3 and communicates with the network object 56 via a wireless link to bridge gateway 62, as do four tire pressure management sensors 58.

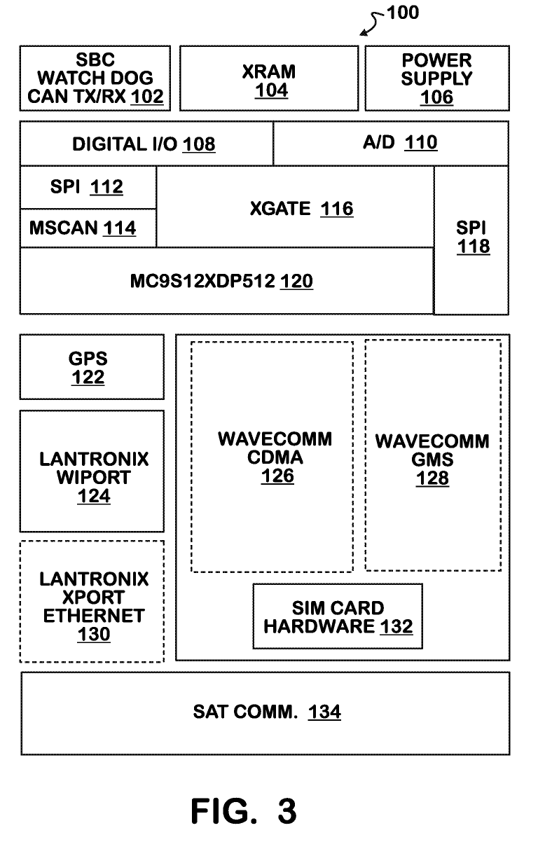

FIG. 3 is a block diagram of a typical bridge gateway 100. The particulars of the diagram are not particularly significant except to say that a bridge gateway must provide the ability to handle communications over networks operating under a variety of communication protocols and provide for wireless communication. To that end appropriate communication blocks 122, 124, 126, 128, 130, 132 and 134 for various protocols are provided as well as a universal asynchronous port 118 for handling communications traffic received over a physical layer or by wireless means. The bridge gateway 100 incorporates a power supply 106 for stepping down vehicle voltage, and sufficient memory 104 to provide translation tables and processing capability to determine which messages need to be passed and the ability to translate the message to a different protocol if required and the usually essential CAN controller 102.

A main processing block includes basic input/output sections 108, 110 (relating to digital and analog communications) and the sections 112, 114, 116 and 120 implementing the processor. The arrangement is by and large conventional network gateway technology.

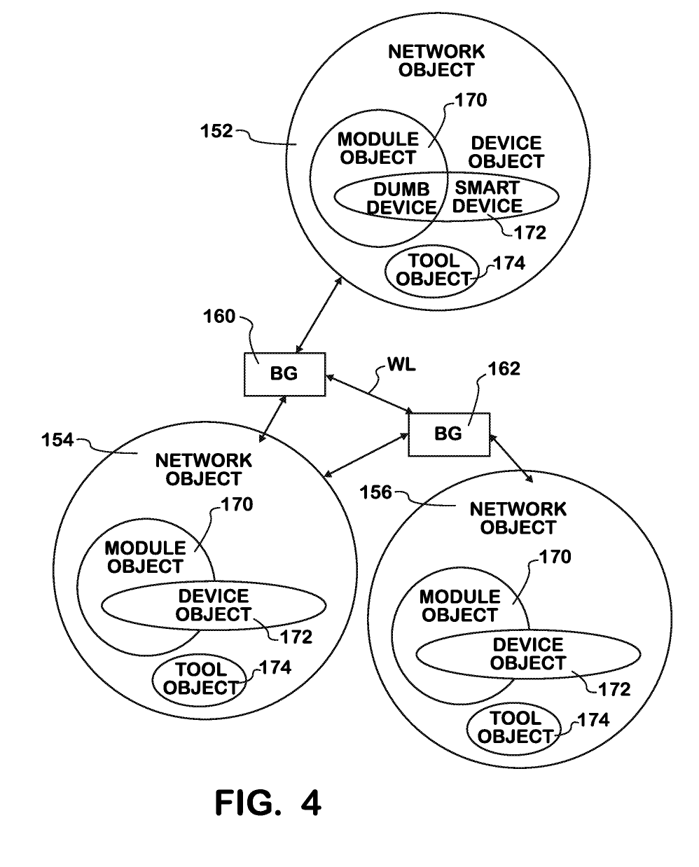

Referring to FIG. 4, a hypothetical topology for a system incorporating three network objects 152, 154, 156 is depicted. The network objects are not distinguished, though network object 154 may be taken as corresponding to a middle zone network object for vehicle, e.g. network object 54 of FIG. 2. Two bridge gateways 160, 162 provide for exchange of data between network objects. Bridge gateway 160 is physically connected to the physical communication media (layers) for network objects 152 and 154. Bridge gateway 162 is physically connected to the physical communication media (layers) for network objects 154 and 156. It is assumed that network objects 152 and 156 are located is physically displaced zones, however, bridge gateways 160 and 162 can establish a wireless link WL allowing traffic from network object 156 which is required by a module object 170 or device object 172 on network object 152 to bypass network object 154, and vice versa. The wireless link WL may be invoked upon failure of network object 154.

Network objects 152, 154 and 156 usually comprise module objects 170 and device objects 172 and may include tool objects 174 from time to time. Device objects 172 may include a module object 170 as an interface to the network object. Device objects 172, as already specified, may be dumb devices or smart devices. Generally dumb devices 172 require a vehicle sensor module (VSM) to provide an interface to the network object.

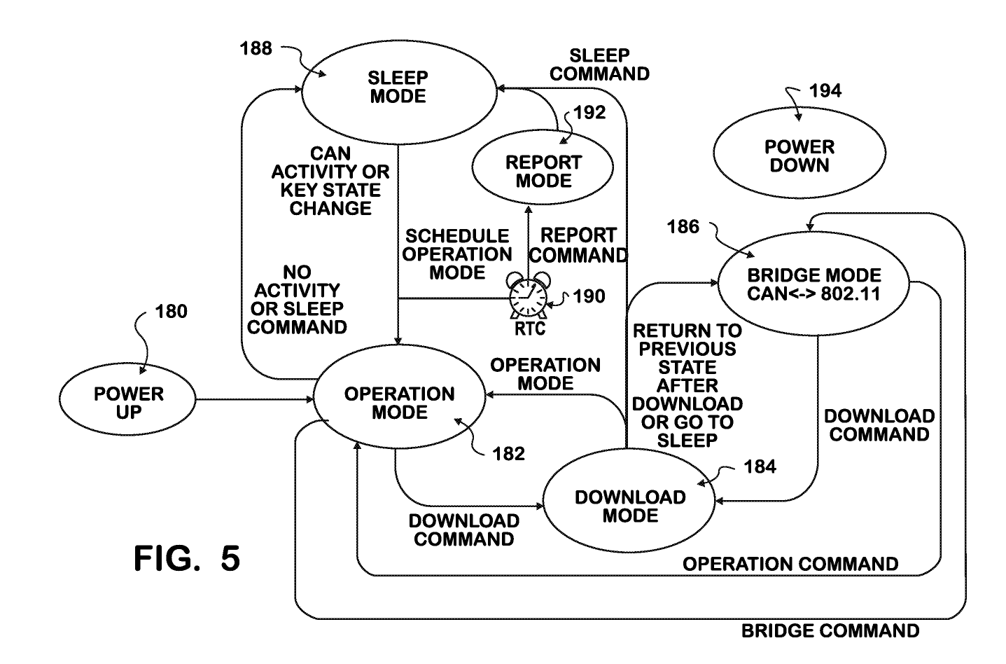

FIG. 5 illustrates a state diagram for a bridge gateway. Upon power up (state 180) a state change to operation mode (state 182) is forced. From the operation (state 182) mode four possible state transitions are possible, including a default power down mode (state 194) which occurs upon a loss of power or when the system is turned off from any state. In operation mode a bridge gateway monitors message traffic on each of the network objects it is connected to (typically two). Upon receipt of a download command a state transition occurs to download mode (state 184). Upon completion of a download a state transition automatically occurs back to the previous state (either operation mode (state 182) or bridge mode (state 186)) or to a sleep mode (state 188). Upon receipt of a message requiring translation to another network object a state transition to bridge mode (state 186) occurs. In bridge mode (state 186) identification of an operation command results in a change of state to operation mode (state 182) and identification of a download command results in a state change to the download mode (state 184).

A lack of activity, or a specific sleep command, results in a change of state to sleep mode (state 188) to save power. Sleep mode is interrupted with network activity or a change in key state (e.g. accessory to start). Periodic events triggered by a system clock 190 may require temporary changes in state from sleep mode (state 188) to a report mode (state 192).

While the invention is shown in only one of its forms, it is not thus limited but is susceptible to various changes and modifications without departing from the spirit and scope of the invention.

What is claimed is:

1. A vehicle communications system comprising:
at least a first network object including a physical, data communication medium;
a bridge gateway physically connected for receiving data traffic on and transmitting data traffic over the data communication medium of said at least first network object;
the bridge gateway including provision for communication with a second network object and for wireless communication with sensor and actuator devices; and
said at least first network object including at least a first module and a first device connected the data communication medium, said at least first module, device and the data communication medium being located in a first spatially defined zone on a vehicle.

2. A vehicle communications system according to claim 1, further comprising:
a second network object connected for exchange of data communication with the bridge gateway, the second network object including a module, a device and a physical communication medium, the module, device and physical communication medium being located in a second spatially defined zone which is substantially non-coincident with the first spatially defined zone; and
the bridge gateway including look up tables for translating messages and providing for transferring messages between the first and the second network objects.

3. A vehicle communications system according to claim 2, further comprising:
a second bridge gateway;
a third network object; and
the second and the third network objects being physically connected to the second bridge gateway for transference of messages between the network objects.

4. A vehicle communications system according to claim 3, further comprising:
the bridge gateway and the second bridge gateway including wireless communications facilities allowing wireless communications between the bridge gateway and the second bridge gateway.

5. A vehicle communications system according to claim 4, further comprising:
the bridge gateway and the second bridge gateway providing a plurality of operating states including a sleep mode for saving power.

6. A vehicle communications system according to claim 4, further comprising:
a second communication medium connecting the bridge gateway and the second bridge gateway, the second communication medium providing a data link for the second network object.

7. A vehicle communications system according to claim 6, further comprising:
at least a first wireless device for communicating with the bridge gateway or the second bridge gateway.

8. A vehicle control system comprising:
a communications physical layer including a plurality of network data communication links with each network data communication link being disposed in a different one of a plurality of zones relative to a vehicle chassis;
at least a first bridge gateway connected between at least first and second network data communications links;
a plurality of modules and network devices physically connected to one of either the first and second network data communications links; and
the first bridge gateway further providing facilities for establishing wireless links, including wireless data links wireless devices mounted on the vehicle chassis.

9. The vehicle control system of claim 8, further comprising:
a third network data communications link; and
a second bridge gateway connected between the second network data communications link and the third network data communications link, the second bridge gateway including facilities for establishing wireless links including a wireless link with the first bridge gateway.

10. The vehicle control system of claim 9, further comprising:
a plurality of sensor and actuator devices providing for wireless links with the first and second bridge gateways.

11. The vehicle control system of claim 10, further comprising:
a hand tool including means for establishing a wireless link when brought into physical proximity of the first or second bridge gateway and thereby becoming a temporary component of the vehicle control system.

12. The vehicle control system of claim 9, further comprising:
the first and second gateways including programming providing for recognition of an introduction of or withdrawal of a network object to provide system dynamic scalability.
